(19) United States
(12) Patent Application Publication
(10) Pub. No.: US 2010/0131360 A1
(43) Pub. Date: May 27, 2010

(54) RATE CARD YIELD MANAGEMENT

(75) Inventors: Scott Shifflett, Stevenson Ranch, CA (US); Steven Hartman, Hermosa Beach, CA (US); Matthew Plummer, Porter Ranch, CA (US); Kara Perry, San Gabriel, CA (US); Tom Furukawa, Rancho Santa Margarita, CA (US); Jacqueline Bleth, Burbank, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/275,654

(22) Filed: Nov. 21, 2008

(51) Int. Cl. G06Q 30/00

(52) U.S. Cl. 705/14.48

(57) ABSTRACT

A system and method are disclosed for allowing networks and publishers to manage the rates of their inventory to optimize their yield. The yield is determined based on a set of rates which may be stored in a rate card. The rates may be established based on targeting attributes. A publisher may adjust its rates on the rate card by selecting a particular attribute and/or rate and modifying the rate by an amount or percentage. The publisher may download its rate card and then upload a modified rate card that includes the adjusted rates.

### BACKGROUND

Online advertising may be an important source of revenue for enterprises engaged in electronic commerce. Processes associated with technologies such as Hypertext Markup Language (HTML) and Hypertext Transfer Protocol (HTTP) enable a web page to be configured to display advertisements. Advertisements may commonly be found on many web sites. For example, advertisements may be displayed on search web sites and may be targeted to individuals based upon search terms provided by the individuals. Other web site publishers, such as news and sports web sites, may provide space for advertisements. The publishers of these web sites may sell advertising space to advertisers to supplement the costs associated with operating the web sites as well as to turn a profit.

As the Internet has grown, the number of publishers and their web sites available for hosting advertisements has increased, as well as the diversity between web sites. As a result of this increase, it has become increasingly difficult for publishers to optimize the revenue generated by the advertisements on their sites. Publishers may have an inventory of advertisement slots, but may have difficulty improving the yield produced by that inventory. This may result in a lower rate of return for the publisher. That publisher may earn a higher yield for its inventory when the inventory is sold and priced more effectively.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a diagram of an exemplary network system;

FIG. 2 is a diagram of an exemplary rate card interface system;

FIG. 3 is a diagram of exemplary rates;

FIG. 4 is a diagram of exemplary targeting attributes;

FIG. 5 is an exemplary interface screen for creating or editing a base rate;

FIG. 6 is another exemplary interface screen for creating or editing a rate adjustment;

FIG. 7 is an exemplary rate card interface screen;

FIG. 8 is another exemplary rate card interface screen with rate card actions; and

FIG. 9 is flowchart of exemplary rate card processing.

### DETAILED DESCRIPTION

By way of introduction, a system and method are described that allow networks and publishers to manage the rates of their inventory to attain the highest yield. The yield is determined based on a set of rates which may be stored in a rate card. The rates may be established based on targeting attributes. Using the rate card, a publisher may be able to adjust its rates by selecting a particular attribute and/or rate and modifying the rate by an amount or percentage. The publisher may download its rate card and then upload a modified rate card that includes the adjusted rates.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below.

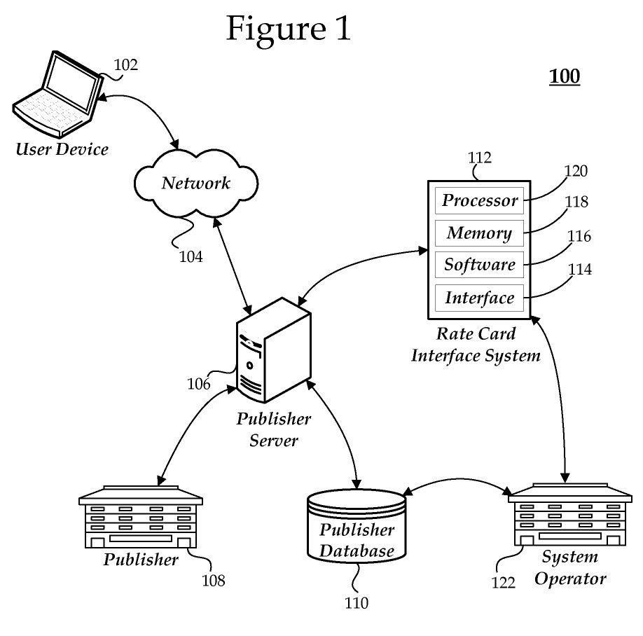

FIG. 1 depicts a block diagram illustrating one embodiment of an exemplary advertising system 100. The advertising system 100 may provide a platform for publishers to be able to manage and control their inventory of advertisement slots. In the advertising system 100, a user device 102 is coupled with a publisher server 106 through a network 104. The publisher server 106 may be operated by and/or coupled with a publisher 108, as well as being coupled with a publisher database 110. A system operator 122 is coupled with a rate card interface system 112 that may be coupled with the publisher server 106. Herein, the phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The user device 102 may be a computing device which allows a user to connect to a network 104, such as the Internet. Examples of a user device include, but are not limited to, a personal computer, personal digital assistant (“PDA”), cellular phone, or other electronic device. The user device 102 may be configured to allow a user to interact with the publisher server 106, the rate card interface system 112, or other components of the advertising system 100. The user device 102 may include a keyboard, keypad or a cursor control device, such as a mouse, or a joystick, touch screen display, remote control or any other device operative to allow a user to interact with the publisher server 106 via the user device 102. In one embodiment, the user device 102 is configured to request and receive information from the publisher server 106, such as a web page that is provided by the publisher 108. The web page may include advertisements and those advertisements may be displayed in advertisement slots or spaces that are part of the publisher's inventory of advertisements. In an alternative embodiment, software programs other than web browsers may also display advertisements received over the network 104 or from a different source. The user device 102 may be configured to access other data/information in addition to web pages over the network 104 using a web browser, such as INTERNET EXPLORER® (sold by Microsoft Corp., Redmond, Wash.) or FIREFOX® (provided by Mozilla).

In one embodiment, the publisher server 106 provides an interface to a network 104 and/or provides a web page to the user device 102. The publisher server 106 may be operated by the publisher 108 that maintains and oversees the operation of the publisher server 106. The publisher server 106 may be a web server that provides the user device 102 with pages (including advertisements) that are requested by a user of the user device 102. In particular, the publisher server 106 may provide a web page, or a series of web pages when requested from the user device 102. For example, the publisher may be a news organization, such as CNN® that provides all the pages and sites associated with www.cnn.com. Accordingly, when the user device 102 requests a page from www.cnn.com, that page is provided over the network 104 by the publisher server 106. As described below, that page may include advertising space or advertisement slots that are filled with advertisements on the page. The publisher's inventory includes the advertising space and/or advertising slots in which advertisements are displayed. The publisher server 106 may receive advertisements from at least one advertiser server (not shown) that are displayed in pages provided by the publisher server 106. In one embodiment, a rate card interface system 112 may be used by the publisher 108 to adjust and optimize the rates for its inventory.

The publisher database 110 may be coupled with the publisher server 106 and may store the publisher's pages or data that is provided by the publisher server 106. In addition, the publisher database 110 may include records or logs of at least a subset of the requests for data/pages submitted to the publisher server 106 over a period of time. In one example, the publisher database 110 may include a history of Internet browsing data related to the pages provided by the publisher server 106. The data stored in the publisher database 110 may relate to or include various user information, such as preferences, interests, profile information or browsing tendencies, and may include the number of impressions and/or number of clicks on particular advertisements. The data may include targeting information related to the targeting attributes discussed below.

The publisher database 110 may store records/data regarding the publisher's inventory, as well as storing advertisements from advertisers that may be displayed by the publisher's inventory. The data, including the targeting attributes data, may be used by the rate card interface system 112 for optimizing the yield of the publisher's inventory by adjusting the rates in its rate card, as discussed below. In an alternate embodiment, the system operator 122 may be coupled with the publisher database 110. The system operator 122 may control and/or access any of the data stored in the publisher database 110.

The rate card interface system 112 may be controlled by a system operator 122. The system operator 122 may provide advertising services for the publisher 108. For example, Yahoo!®, through its Yahoo! Publisher Network®, may provide publishers, such as publisher 108, with advertising. The publisher 108 may utilize the system operator 122 for coordinating and optimizing the advertizing on its sites. In one embodiment, the system operator 122 may provide a service for a number of publishers. The system operator 122 may provide a rate card for each of the publishers or for each site for a particular publisher. The rate card interface system 112 may be coupled with the publisher server 106 for providing the publisher 108 with an interface for adjusting its rates. The publisher 108 may utilize the rate card interface system 112 to optimize the rates paid for its inventory, by downloading its rate card and adjusting its rates.

The rate card may be a document or file containing prices and descriptions for the advertisement placement options available on a publisher's site. In one embodiment, the rate card may be a Microsoft Excel® file, such as a file with the extension “.xls.” In alternate embodiments, the rate card may be a different type of file, such as a spreadsheet, database, html, or word processing file. Each publisher may have one rate card for all of its pages/sites, or may have multiple rate cards for different pages/sites. The rate card may include base rates and/or adjustment/mark-up rates. An adjustment/mark-up rate card may be used to apply mark-ups or adjustments to at least some of the rates in a rate card, while the base rates may include a default rates that are established before any adjustments or mark-ups.

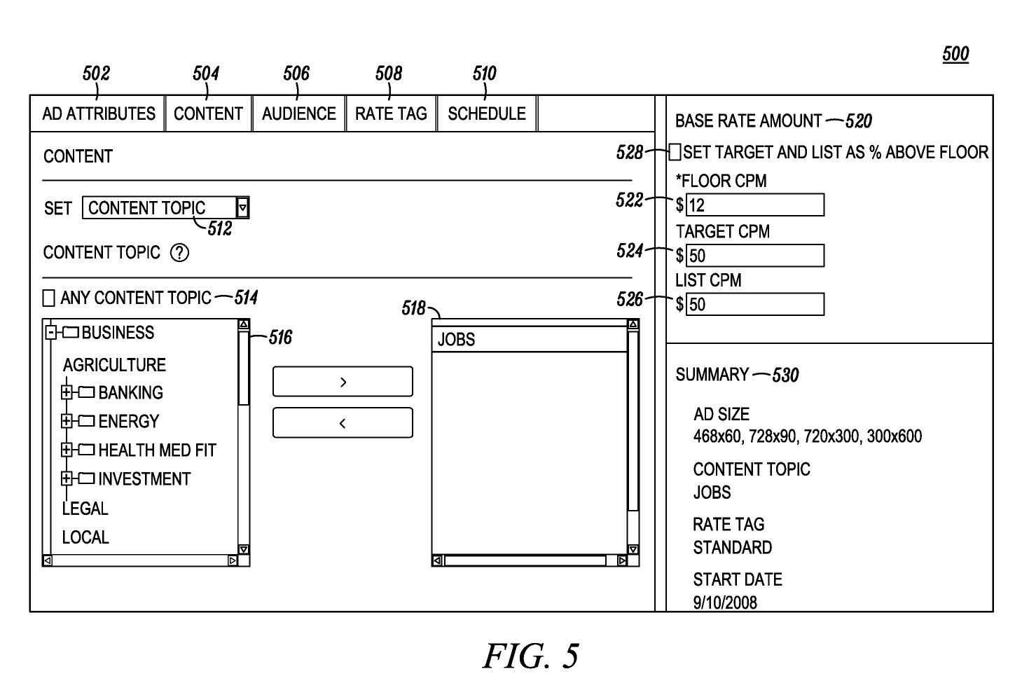

The rate card may include information such as the items listed on the column headings illustrated as tabs in FIG. 5, as well as additional targeting attributes and various rates or prices. For a rate card for a site, the site definition may include the name, URL, status and date. The prices may include what the advertiser pays the publisher for displaying the advertiser's advertisement in a particular ad space. In one example, the rate may be the cost per thousand (CPM) impressions for an advertisement, a cost per click (CPC), or a cost per acquisition/action (CPA).

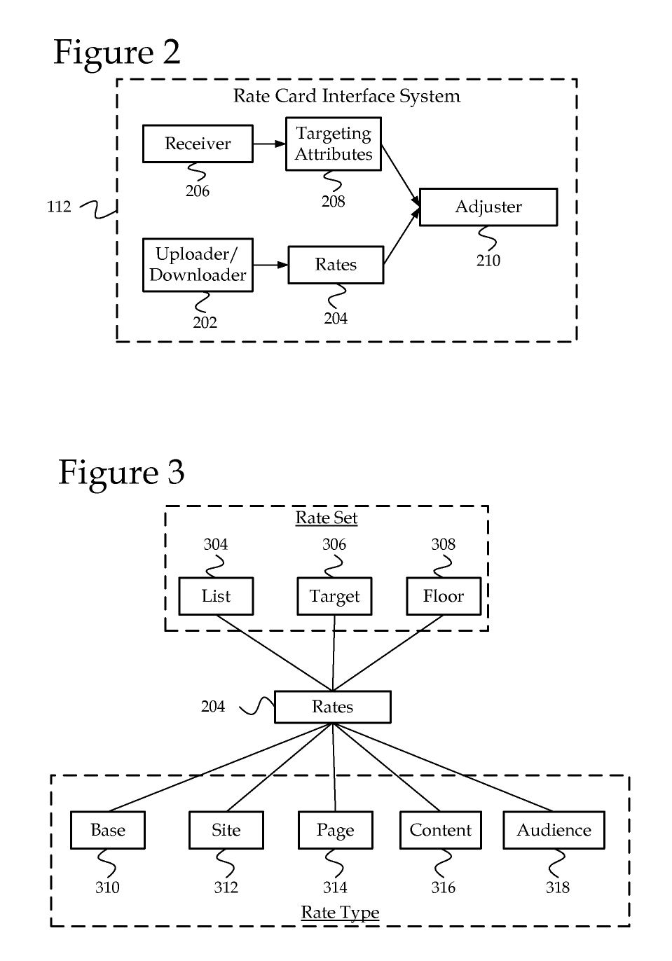

The rate card's prices may be targeted to particular categories or attributes, such as the targeting attributes 208 discussed below. The rate card may include a listing or description of all the attributes that are targeted and provide a price or prices for those attributes. A pricing engine (not shown) may generate prices based on the page or site and based on the targeted attributes. The rate card is discussed below with respect to the rates 204 in FIG. 2 and FIG. 3.

The rate card interface system 112 is illustrated in FIG. 2. The rate card interface system 112 may include an uploader/downloader 202 for providing rates 204 to an adjuster 210. Likewise, a receiver 206 may provide targeting attributes 208 to the adjuster 210. The uploader/downloader 202 may allow the publisher 108 to download its rate card to make adjustments to the rates. Once the adjustments have been made, the rate card may then be uploaded to the rate card interface system 112 and the new rates will be used. In particular, the rates 204 are provided to the adjuster 210 which performs the adjustments from the uploaded rate card.

The rates 204 in the rate card interface system 112 are further described with respect to FIG. 3. The rates 204 may include a set of rates, such as a list rate 304, a target rate 306, and/or a floor rate 308. The list rate 304 may be the rate that is displayed or advertised. The target rate 306 may be the preferred rate that the publisher would like to receive for its ad space. The floor rate 308 may be the minimum rate that the publisher would accept for selling its ad space. The list rate 304 may be between the target rate 306 and the floor rate 308. The publisher may use the target rate 306 as the list rate 304 when attempting to increase the revenue received for a spot. Conversely, the publisher may use the floor rate 308 as the list rate 304 when attempting to sell the ad spot quickly.

The rates 204 in the rate card interface system 112 may include different types, such as base 310, site 312, page 314, content 316, and/or audience 318. The base rate type 310 may include a standard or default rate that is not specialized or does not include additional features. For example, a publisher could begin with a base rate 310 and then modify the rate based on various targeting attributes. Alternatively, the default rate may be applied when a base rate is not found that matches the targeting in the order. When no base rate fits the placement, the default rate may be the base price. If there is a match with a rate adjustment—for example the placement is for ad size 728×90 and there is an adjustment rate for an ad size 728×90—the default rate and the rate adjustment may be combined to create the final rate for that ad placement. Accordingly, the default rate may be a base rate that is not specialized. A rate adjustment may define an incremental change in a base rate. Adjustments may set premiums and apply discounts depending on the conditions for ad placement.

The site rate 312 may be specific to a particular site, while the page rate 314 may be specific to a particular page. The content rate 316 may be dependent on the content of the displaying page and/or advertisement. The audience rate 318 may be dependent on the viewer of the advertisement. The site 312, page 314, content 316, and audience 318 rate types are further described with respect to the targeting attributes 208. The rates 204 may be based on or adjusted for different targeting attributes. The rate adjustments may also be referred to as mark-ups or add-ons and the adjustments may apply across all rates, or may be specified to particular rates.

Referring back to FIG. 2, a receiver 206 may receive advertising, user, and/or tracking data. In one embodiment, the receiver 206 receives data that is used for the targeting attributes 208. Any changes to the targeting attributes 208 may be performed by the adjuster 210.

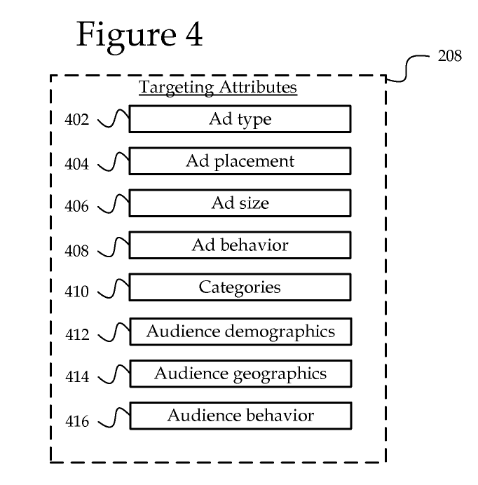

FIG. 4 is a diagram of exemplary targeting attributes 208. The targeting attributes 208 may be features that influence a particular rate. Any of the targeting attributes 208 may be used for adjusting the rates based on particular features of the targeting attributes. The ad type 402 attribute may include the type or format of an advertisement. For example, a banner ad may have a higher rate than sidebar ad. The ad type 402 may include banner, sidebar, pop-up ads. The ad placement 404 may include the position on the page, such as the top, bottom, side, or whether the ad hovers on the page. Additional ad types may include in page-above the fold, in page-below the fold, in page-spans the fold, overlay video, post-roll video, or pre-roll video. As with the other targeting attributes 208, a publisher may adjust the rates for a particular ad placement 404. The ad size 406 includes the pixel size of the advertisement. For example a large rectangle ad may be 336×280 and a half banner ad may be 234×60. The ad behavior 408 may include whether the ad is text, images, audio, video, and/or other multimedia. Additional ad behavior 408 may include whether the ad is user-initiated, clickable, expandable, floating, in-page, or interactive.

The categories 410 attribute may include the classification of the ad space inventory. The publisher may designate certain inventory to a particular category. For example, the publisher may want some of its inventory to be categorized as “sports” and other inventory to be categorized as “finance.” The rates may vary depending on the category. For example, the rates for the sports category may be 10% higher than the rates for the other categories, so that when a sports-related advertisement is displayed, its rate is higher than other advertisements. The categories 410 may be based on the site, the page, the content, and/or the advertisement. When advertisements are categorized, those categories may be used by the rate card interface system 112 to determine and/or adjust rates. The categories may be from a standard taxonomy, or may be custom categories or custom sections that are established by the publisher 108, system operator 122, or advertisers.

Audience demographics 412 may include features regarding the audience or users who view the publisher's site/page and its advertisements. The advertisements may be targeted to particular users and likewise, the publisher's advertising inventory may be adjusted based on the viewer. The audience demographics 412 may include gender, age, and/or income. In one embodiment, the publisher may increase its rates for males between the ages of 18-49 and lower its rates from users over the age of 65.

Audience geographies 414 may include the physical location of the audience. An audience may be targeted based on geographical targeting data. For example, the country, region, state, zip code, city, town and/or neighborhood may be relevant for adjusting the rates. The audience geographies 414 may determine rates. For example, the publisher may increase rates when the audience is located in a large metropolitan area.

Audience behavior 416 may be a measure of a user's browsing history or interactions with advertisements. The audience behavior 416 may be embodied in a user ad profile including user behavior with regard to ads for tracking advertising features each user may be more likely to respond. Additionally, data about the time of day, colors, shopping items, webpage content, and time of day may be included with the profile. The audience behavior 416 may further include user information such as an email address, occupation, industry, ethnographic information, purchase history, and/or personal interests of users. The rates for inventory may be increased for users who have a tendency to click-through advertisements versus users whose browsing history suggests fewer click-throughs.

Additional targeting attributes 208 may include psychographics, technology, language, or other categories. Psychographics may include attributes relating to personality, values, attitudes, interests, or lifestyles. Technology may include the browser, operating system, network connection, and/or computer of a user. For example, the rates may be increased for users that have a broadband network connection, or users that have a wireless network. Language may include different language ads. There may be other targeting attributes that are used by publishers for determining and adjusting rates for their ad space inventory.

Referring back to FIG. 1, the rate card interface system 112 may be a computing device or include components of a computing device. The rate card interface system 112 may include a processor 120, memory 118, software 116 and an interface 114. The rate card interface system 112 may be a separate component from the publisher server 106 that is controlled by the system operator 122, or may be combined as a single component or device.

The processor 120 in the rate card interface system 112 may include a central processing unit (CPU), a graphics processing unit (GPU), a digital signal processor (DSP) or other type of processing device. The processor 120 may be a component in any one of a variety of systems. For example, the processor 120 may be part of a standard personal computer or a workstation. The processor 120 may be one or more general processors, digital signal processors, application specific integrated circuits, field programmable gate arrays, servers, networks, digital circuits, analog circuits, combinations thereof, or other now known or later developed devices for analyzing and processing data. The processor 120 may operate in conjunction with a software program, such as code generated manually (i.e., programmed).

The processor 120 may be coupled with a memory 118, or the memory 118 may be a separate component. The interface 114 and/or the software 116 may be stored in the memory 118. The memory 118 may include, but is not limited to computer readable storage media such as various types of volatile and non-volatile storage media, including to random access memory, read-only memory, programmable read-only memory, electrically programmable read-only memory, electrically erasable read-only memory, flash memory, magnetic tape or disk, optical media and the like. The memory 118 may include a random access memory for the processor 120. Alternatively, the memory 118 may be separate from the processor 120, such as a cache memory of a processor, the system memory, or other memory. The memory 118 may be an external storage device or database for storing recorded data. Examples include a hard drive, compact disc (“CD”), digital video disc (“DVD”), memory card, memory stick, floppy disc, universal serial bus (“USB”) memory device, or any other device operative to store data. The memory 118 is operable to store instructions executable by the processor 120.

The functions, acts or tasks illustrated in the figures or described herein may be performed by the programmed processor executing the instructions stored in the memory 118. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 120 is configured to execute the software 116. The software 116 may include instructions for providing, accessing, downloading, uploading, and modifying a rate card.

The interface 114 may communicate with any of the user device 102, the publisher server 106, and/or the system operator 122. The interface 114 may include a user interface configured to allow a user to interact with any of the components of the rate card interface system 112. As described, the publisher 108 may access its rate card through the interface 114 by downloading it from the rate card interface system 112 and may modify its rate card and upload the rate card back to the rate card interface system 112 through the interface 114. In one embodiment, the interface 114 is the uploader/downloader 202 and/or the receiver 206 and allows communication from the publishers with the system 112. The communication is not limited to downloading and uploading its rate card and the publisher 108 may access, view, and edit its rate card without downloading the rate card. For example, the rate card may be displayed in HTML format over a network, such as a web page, and the publisher after logging on to the web page can modify the rate card just as if the rate card were downloaded. Accordingly, in one embodiment, the interface 114 may be a web page that allows real-time modifications and adjustments to the rate card.

In one embodiment, there may be an editable (pending) rate card, in which changes can be made without modifying the live (active) rates. The pending rate card may be activated which replaces the live card and the active rates. Accordingly, the publisher can work with the base rates and adjustments to make the right combination before committing the changes. There may be two rate cards, one being a live card used by the system to price ad placement and another pending card that is not live.

The interface 114 may be a user input device or a display. The interface 114 may include a keyboard, keypad or a cursor control device, such as a mouse, or a joystick, touch screen display, remote control or any other device operative to interact with the rate card interface system 112. The interface 114 may include a display coupled with the processor 120 and configured to display an output from the processor 120. The display may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 120, or as an interface with the software 116 for providing input parameters.

The present disclosure contemplates a computer-readable medium that includes instructions or receives and executes instructions responsive to a propagated signal, so that a device connected to a network can communicate voice, video, audio, images or any other data over a network. The instructions may be transmitted or received over the network via a communication port or may be a separate component. The communication port may be created in software or may be a physical connection in hardware. The communication port may be configured to connect with a network, external media, display, or any other components in system 100, or combinations thereof. The connection with the network may be a physical connection, such as a wired Ethernet connection or may be established wirelessly as discussed below. Likewise, the connections with other components of the system 100 may be physical connections or may be established wirelessly.

Any of the components in the advertising system 100 may be coupled with one another through a network, including but not limited to the network 104. For example, the rate card interface system 112 may be coupled with the publisher server 106 and/or the system operator 122 over a network. As another example, the advertiser database 126 may be coupled with the publisher server 106 and/or the rate card interface system 112 over a network. Accordingly, any of the components in the advertising system 100 may include communication ports configured to connect with a network.

The network or networks that may connect any of the components in the advertising system 100 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another.

As described, the rate card interface system 112 may be utilized by a publisher for creating and adjusting the rates at which its ad space inventory is paid. FIG. 5 is an exemplary interface screen 500 for editing or creating a base rate. A publisher may access the rate card interface system 112 and view the interface screen 500 for initially generating a rate card. In one embodiment, the screen is a web page that is accessed by the publisher for viewing and/or modifying the rate card, and in another embodiment, the screen is representative of a rate card file that is downloaded and modified by a publisher.

The interface screen 500 is one embodiment of the interface for setting rates and generating a corresponding rate card based on those rates. The interface screen 500 may include tabs such as ad attributes 502, content 504, audience 506, rate tag 508 and schedule 510. The ad attributes 502 include the targeting attributes 208 discussed above. The content 504 includes the categories of the ad and/or ad space. The audience 506 includes the viewers of the ads, such as the audience targeting attributes 208. The schedule 510 may include a time frame for a particular rate or a rate adjustment. For example, the publisher 108 may increase its rate by 50% for the next week. Rate tags may set different rates for different sales channels. A different sales channel may be a partnership deal or agreement in which a publisher has the ability to sell inventory for a share of the revenue for another publisher. Using a rate tag may create a rate that may apply when a partner sells ad placements on another publisher's site.

The interface screen 500 illustrates content selection as shown in the drop down menu 512. The folder hierarchy 516 illustrates different categories of content that may be identified. Alternatively, the any content topic 514 may be selected to identify all content regardless of the category. When a category is selected, that category is displayed in the selected box 518. As illustrated, the category “jobs” has been selected and is displayed in the selected box 518. Accordingly, the summary 530 illustrates that the content topic is “jobs.”

The base rate amount box 520 illustrates the rates. The rates may be established for a particular category of content, which is “jobs” in the interface screen 500. In addition, the rates may be based on ad attributes 502 or the audience 506. The base rate amount 520 may include a floor rate 522, a target rate 524, and a list rate 526. As illustrated, the rates 522, 524, 526 may be cost per thousand (CPM). In the interface screen 500, the target rate 524 and the list rate 526 are both $50 and the floor rate 522 is $12. In alternate embodiments, the percentage toggle box 528 may be checked, so that the target and list prices are set as percentages of the floor amount.

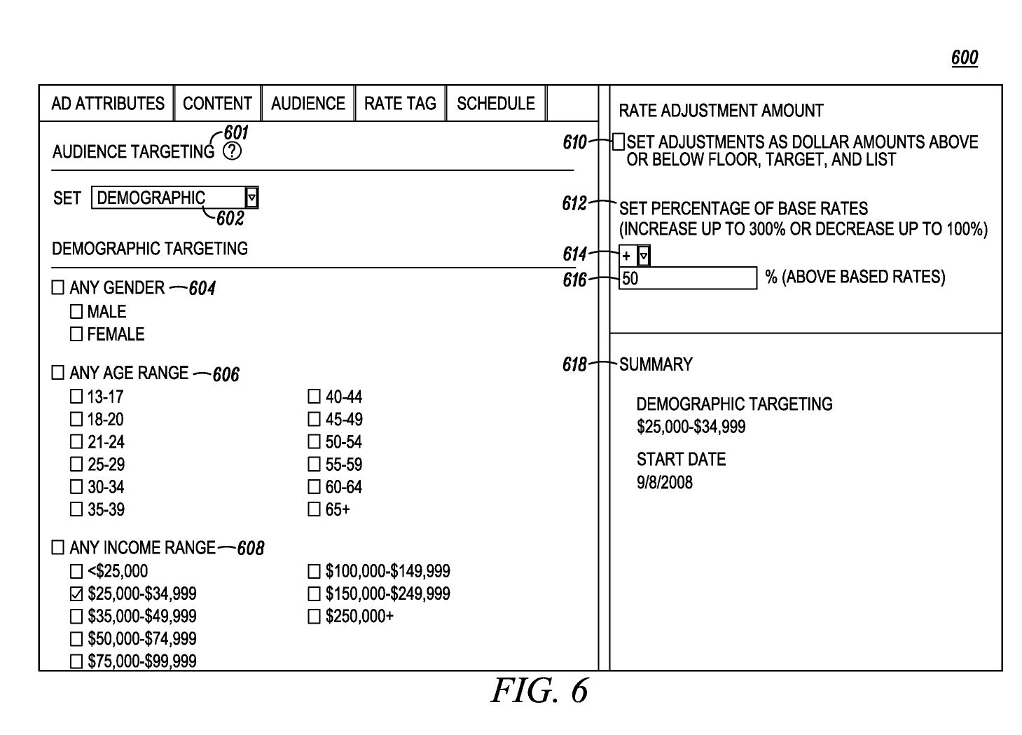

FIG. 6 is an exemplary interface screen 600 for creating or editing a rate adjustment. A rate adjustment may allow for an adjustment across all the base rates. For example, all rates may be increased by a dollar amount or a percentage. A pricing engine (not shown) may consider base rates and adjustments to develop the final rate based on the best match combination. As described a rate adjustment may be a type of rate, and may include an editing, modification, change, or adjustment to one or more rates.

The interface screen 600 illustrates editing a rate based on audience targeting 601. In particular, the demographic features 602 of the audience are used for adjusting rates. In particular, the gender 604, age 606, and income 608 are demographic features or attributes which may be selected. The rate may be adjusted as a percentage 612. The direction box 614 allows the rates to be adjusted up or down. The publisher may wish to decrease the rates or increase the rates. The percent amount box 616 includes the percentage for adjusting the rate. Conversely, in the amount box 610, the adjustment may be based on an amount rather than a percentage. The summary 618 illustrates that the income range from $25K-$34,999 is set at 50% above the base rates. In other words, the publisher is increasing his rates by 50% when an audience with an income between $25K-$34,999K is targeted. FIG. 6 illustrates one embodiment of an attribute whose rate may be adjusted. Any of the other targeting attributes 208, including the ad attributes, content, and audience may be specified for rate adjustments.

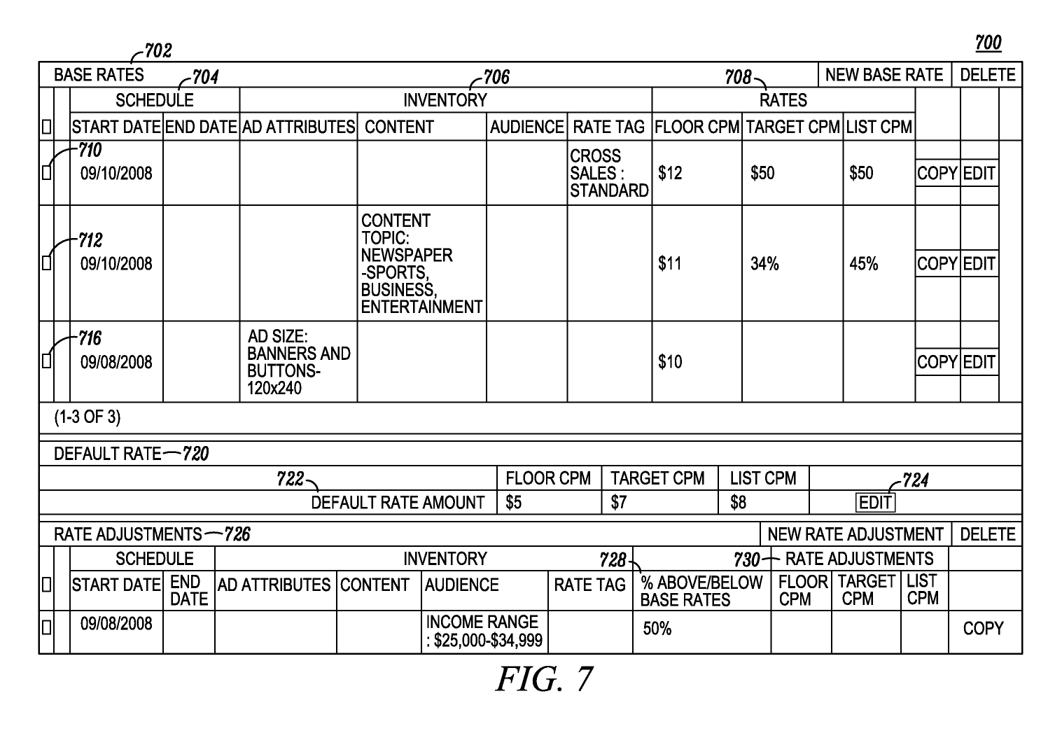

FIG. 7 is an exemplary rate card interface screen 700. The interface screen 700 further illustrates the scheduling and display of rate information. The base rate 702 information includes the schedule 704, inventory 706, and rates 708. The schedule 704 identifies the time frame in which a rate is effective. As illustrated, a first schedule 710 begins on Sep. 10, 2008. A second schedule 712 also begins on Sep. 10, 2008, but is related to the categories, newspaper-Sports, Business, and Entertainment. The third schedule 716 begins on Sep. 8, 2008, but is related to ads that are banners and buttons of size 120×240. The inventory 706 includes ad attributes, content, audience and rate tag. The rates 708 illustrate the floor, target, and list rates. The interface screen 700 illustrates current rates for particular attributes. Additional rates may be added, or the rates may be edited from the interface screen 700. In addition, the default rate 720 is illustrated as an amount 722 that includes a floor, target, and list. The default rate may be edited 724. The interface screen 700 further illustrates rate adjustments 726. The rate adjustment may be based on the inventory discussed above. The adjustment percentage 728 may be a percent above or below the base rates. Further, rate adjustments 730 may be made to the floor, target, and list. As illustrated, the rate is raised 50% for an audience with an income between $25K-$34,999K.

FIG. 7 illustrates an interface screen 700 that may be used by a publisher for selling its inventory. In particular, the publisher is offered flexibility in adding and editing rates based on various inventory attributes. The publisher can establish and monitor a number of different rate adjustments. The rate adjustments allow the publisher to optimize their ad space and improve the yield from their inventory. The attributes and features described and illustrated are merely exemplary and there may be additional attributes and features which are customizable for use by the publisher. In one embodiment, the publisher may create custom attributes which are used to further adjust rates.

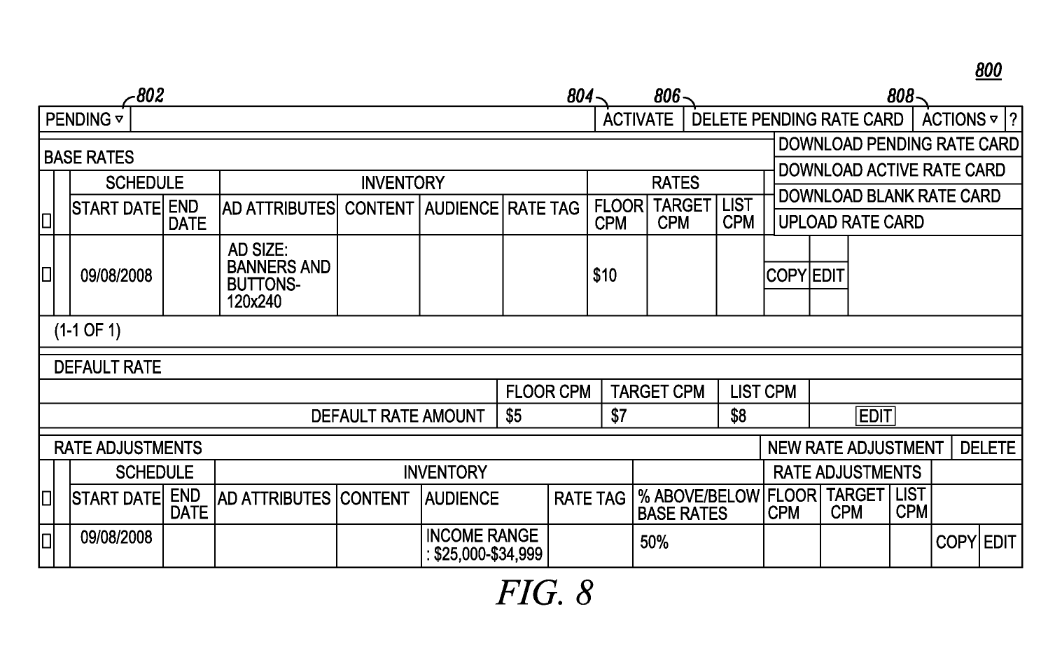

FIG. 8 is another exemplary rate card interface screen 800 with rate card actions. The interface screen 800 illustrates pending 802 rates. The rates may be activated using actuator 804, which makes the rates in the card active. For example, when a rate card is created it must be activated for the rates to take effect. Likewise, when a rate card is modified, the changes do not take effect until the modified rate card is activated. The activation may be scheduled for a particular time period as discussed above. The rate card may also be deleted using actuator 806. Additional actions 808 may be performed with a rate card. For example, the actions available using actuator 808 may include downloading a pending rate card, downloading an active rate card, downloading a blank rate card, or uploading a rate card. As discussed, the publisher may download a rate card and establish/modify rates to the rate card before uploading the modified card back into the system to be activated. The rates are modified off-line when the rate card is downloaded, allowing the previous rates to remain active. After the off-line edits the rate card is uploaded and once it is activated, the new rates are active.

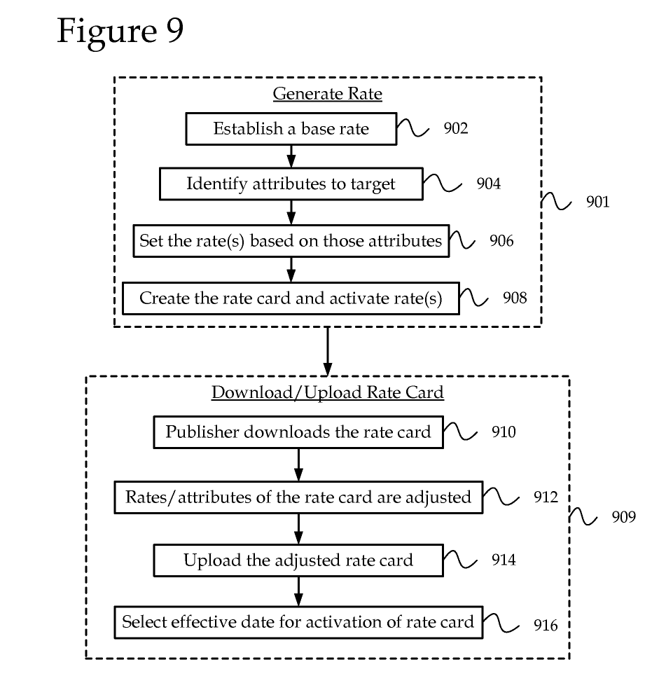

FIG. 9 is flowchart of exemplary rate card processing. In block 901, a rate is generated. Initially, a base rate is established in block 902. A base rate may be established for each page or for each site of the publisher. In block 904, attributes are identified for targeting. The attributes may include the targeting attributes 208 discussed above. The publisher identifies those attributes by which the rate should be adjusted. The rate is then set based on those identified attributes in block 906. The rate card is created and the rates are activated in block 908.

The rate card may be downloaded and uploaded in block 909. In block 910, the publisher can download the rate card. The rate card may be an editable file, such as a spreadsheet or database file. In one embodiment, the rate card is a Microsoft Excel® file. The downloaded rate card can be adjusted in block 912. In particular, the rates, attributes, schedule, pages, and other features of the rate card may be adjusted. The adjusted rate card is then uploaded as in block 914. The publisher may receive an alert once the upload has completed. In one embodiment, the publisher may be locked from making changes to an active or pending rate card while the upload is in process. The uploaded rate card may have a pending rate card status until it is activated and the rates are given an effective date as in block 916. Upon activation an existing rate card may be replaced by the uploaded rate card. The rate generation in block 901 may be with a rate card file that is initially downloaded (such as a blank rate card), updated and then uploaded as described.

When uploading, the publisher may receive a warning with the option to proceed or an error notification that the upload cannot be completed successfully. Warnings may be provided for duplicate rate cards, expired dates, or if adjustments made off-line to the rate card file are not included in the uploaded file. In addition, if a pending rate card exists, the publisher may be warned during an upload that the pending rate card will be replaced with the uploaded rate card. Errors may include when a column heading or attribute is not recognized, a value is not recognized, a floor/target/list price is missing, or the site listed in the rate card is different than the site targeted for the upload. If an error is encountered during an upload, such as the receipt of a partial rate card, the rate card may be rolled back to the previous rate card.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

We claim:

1. A method for managing a rate card comprising:
providing a rate card that includes rates for a publisher's inventory, wherein the rates are at least partially based on attributes to target;
receiving a request from the publisher for downloading the rate card;
providing the rate card to the publisher through a download, wherein the rate card is modified by the publisher, further wherein the modifications include adjustments to the rates;
receiving the edited version of the rate card through an upload by the publisher; and
activating the uploaded rate card, wherein the adjusted rates replace the rates for the publisher's inventory.

2. The method of claim 1 wherein the modifications further comprise attributes that the publisher targets with the inventory, further wherein the rates are adjusted based on the attributes that are targeted.

3. The method of claim 2 wherein the attributes comprise ad type, ad placement, ad size, ad behavior, categories, audience demographics, audience geographies, audience behavior, or combinations thereof.

4. The method of claim 1 wherein the activation comprises establishing an effective date for the adjusted rates to take effect.

5. The method of claim 1 wherein the rate card comprises a file that is edited off-line after being downloaded.

6. The method of claim 5 wherein the file comprises a MICROSOFT EXCEL spreadsheet.

7. The method of claim 1 wherein the rates comprise a price of an advertisement to be displayed with at least part of the publisher's inventory.

8. The method of claim 7 wherein the price comprises a cost per thousand (CPM) impressions for an advertisement, a cost per click (CPC), a cost per acquisition/action (CPA), or combinations thereof.

9. In a computer readable storage medium having stored therein data representing instructions executable by a programmed processor for modifying a rate card, the storage medium comprising instructions operative for:
generating a rate card including rates based on targeting attributes;
receiving a request for a modification of at least some of the rates on the rate card, wherein the modification comprises:
a set of the targeting attributes whose rates are modified;
a type of the modification, the type comprising an amount or percentage by which the rates are adjusted; and
a direction of the modification, the direction comprising whether the modification increases the rate or decreases the rate;
activating the at least some of the rates on the rate card based on the modification.

10. The computer readable storage medium of claim 9 wherein the request for a modification comprises downloading of the rate card by a publisher.

11. The computer readable storage medium of claim 10 wherein the activating further comprises:
uploading the adjusted rate card; and
activating the adjusted card from the upload.

12. The computer readable storage medium of claim 9 wherein the activating further comprises:
establishing an effective date for the modification; and
modifying the at least some of the rates according to the modification on the effective date.

13. A system for managing a rate card comprising:
a publisher that has an inventory for sale;
a publisher server coupled with a network through which the inventory is provided;
a rate card comprising rates for selling the inventory;
a rate card interface system coupled with the publisher server and comprising:
an interface through which the publisher can download the rate card; and
an adjuster for modifying the rates of the rate card;
wherein the modified rate card is uploaded by the publisher through the interface for activating the modified rates.

14. The system of claim 13 wherein the rate card further comprises targeting attributes that are used by the adjuster for modifying the rates of the rate card.

15. The system of claim 14 wherein the targeting attributes comprise ad type, ad placement, ad size, ad behavior, categories, audience demographics, audience geographies, audience behavior, or combinations thereof.

16. The system of claim 13 wherein the rate card is modified off-line after downloading and before uploading.

17. A method for providing a rate card to a publisher comprising:
generating a rate card including rates based on targeting attributes;
providing the rate card for download by the publisher, wherein the rate card is downloaded and adjusted by the publisher;
receiving the adjusted rate card when the publisher uploads the adjusted rate card; and
activating rates from the adjusted rate card.

18. The method of claim 17 wherein the adjustments to the rate card comprise:
a set of the targeting attributes whose rates are modified;
a type of the modification, the type comprising an amount or percentage by which the rates are adjusted; and
a direction of the modification, the direction comprising whether the modification increases the rate or decreases the rate.

19. The method of claim 18 wherein the rate card comprises a spreadsheet.

20. The method of claim 19 wherein the rate card comprises a MICROSOFT EXCEL file.

21. The method of claim 18 wherein the publisher adjusts the rate card off-line.
